(19) United States
(12) Patent Application Publication
(10) Pub. No.: US 2026/0171389 A1
(43) Pub. Date: Jun. 18, 2026

(54) Electrodes with Advanced Architecture

(71) Applicants: Board of Trustees of Western Michigan University, Kalamazoo, MI (US); Argonne National Laboratory, Argonne, IL (US)

(72) Inventors: Qingliu Wu, Portage, MI (US); Wenquan Lu, Naperville, IL (US); Massood Z Atashbar, Portage, MI (US); Jian Yang, Kalamazoo, MI (US)

(21) Appl. No.: 18/983,340

(22) Filed: Dec. 17, 2024

Related U.S. Application Data
(60) Provisional application No. 63/610,404, filed on Dec. 14, 2023.

(51) Int. Cl. H01M 4/04; H01M 4/02; H01M 4/36; H01M 4/38; H01M 4/505; H01M 4/525; H01M 4/58; H01M 4/587; H01M 4/62

(52) U.S. Cl. CPC H01M 4/0414; H01M 4/366; H01M 4/386; H01M 4/505; H01M 4/525; H01M 4/5825; H01M 4/587; H01M 4/623; H01M 4/625; H01M 2004/021; H01M 2004/028

(57) ABSTRACT

Embodiments of the present disclosure include a screen-printed anode with three or more layers, where each layer is printed with a different porosity to optimize the electrode for maximum capacity. Embodiments of the present disclosure include a screen-printed anode wherein the anode comprises graphite with a porosity of 100 μm and edge-to-edge differences of 200 to 400 μm. Embodiments of the present disclosure include a LI based cell comprising a screen-printed anode comprising graphite with at least one layer with a porosity of 100 μm and edge-to-edge differences of 200 to 400 μm; a screen printed cathode comprising a Li-based active material with a pore diameter of about 1000 μm.

### CROSS REFERENCE TO RELATED APPLICATIONS

The present application claims the benefit of U.S. Provisional Application 63/610,404, filed Dec. 14, 2023, the contents of which are incorporated herein in their entirety.

### STATEMENT REGARDING FEDERALLY SPONSORED RESEARCH

This invention was made with US Government support under Grant DE-EE0009111 awarded by the Department of Energy. The Government has certain rights in the invention.

### TECHNICAL FIELD

The present disclosure relates to systems and methods that may be utilized for roll-to-roll processes to fabricate electrodes with precisely controlled porous architectures, which are crucial for fast-charging lithium-ion and other cells of various chemistries, and improved electrodes made from the same.

### BACKGROUND OF THE INVENTION

Roll-to-roll (R2R) processing has been widely adopted by manufacturers to produce electrodes for commercial lithium-ion batteries (LIB). However, to enable the widespread adoption of LIBs for transport, grid storage, and other applications, additional advances in electrode manufacturing processes are required to further reduce battery pack cost. Furthermore, it is a challenge to employ the current state-of-art (SOA) R2R process to fabricate electrodes with precisely controlled porous architectures, which are crucial for fast-charging cells. To overcome these drawbacks, we have developed a novel printing process to fabricate advanced electrodes for fast charging LIBs; embodiments of the present invention include electrodes made using the same with improved porous structures.

### SUMMARY

Embodiments of the present disclosure include a screen-printed anode with three or more layers, wherein each layer is printed with a different porosity to optimize the electrode for maximum capacity. In others, the anode comprises graphite or silicon as the active material. In others, the anode further comprises a conductive additive, and a binder, wherein the ink used to produce the anode further comprises a solvent.

In others, the graphite is selected from MAGE, MAGE3, P66 (Phillips 66), P5, P10, P15, and T16 or a mixture thereof. In others, the binder is selected from one or more of polyvinylpyrrolidone (PVP), polyacrylic acid (PAA), polyvinylidene difluoride (PVDF), carboxymethyl cellulose (CMC), styrene butadiene rubber (SBR) or a mixture thereof. In yet others, the solvent is selected from N-methyl-2-pyrrolidone (NMP), water, ethylene glycol acetate, isopropyl, and ethanol or a mixture thereof.

In yet others, the graphite is Phillips 66, the conductive additive is carbon black, and the binder is PVDF.

In others, the anode comprises three layers, with the top layer having a higher porosity than the middle layer, and the middle layer has a higher porosity than the lower layer. In yet others, the average porosity of each layer ranges from 100 μm to 1000 μm.

In others, the porosity of the lowest layer is about 20%, the middle layer about 30% and upper layer about 40%. In others, the ink used to print the anode further comprises cellulose nanofibers.

Embodiments of the present disclosure include a screen-printed anode wherein the anode comprises graphite with a porosity of 100 μm and edge-to-edge differences of 200 to 400 μm.

Embodiments of the present disclosure include a LI based cell comprising a screen-printed anode comprising graphite with at least one layer with a porosity of 100 μm and edge-to-edge differences of 200 to 400 μm; a screen printed cathode comprising a Li-based active material with a pore diameter of about 1000 μm.

In others the Li-base active material is selected from LiFePO₄ and Li2CoO₃ LiNixCo1−x−yMn_{y}O₂ (NCM) or mixtures thereof. In yet others, the cathode material is printed with an ink comprising a solvent selected from water, isopropyl, ethanol, NMP and their mixtures. In others, the screen-printed anode comprising graphite is comprised of at least three layer with differing porosities.

### BRIEF DESCRIPTION OF THE DRAWINGS

FIG. 1 is a photograph of representative facilities of an XRD (top), rheometer (bottom left) and aerosol jet printer (bottom right), used for material/ink characterizations and printed electrode fabrication;

FIG. 2 is a photograph of screen printed anodes with baseline Mage-3 (top) and Phillips 66 (bottom) graphite;

FIG. 3 is a photograph of screen printed cathodes from NMP-based inks with solid content of 50% (top) and 70% (bottom);

FIG. 4 is a graph of the rheology of certain NMP-based anode inks used for printed electrodes;

FIG. 5 is a photograph of graphite anodes produced through the flexographic (top) method and Si anode produced through aerosol jet printing method (bottom);

FIG. 6 is a photograph of graphite anodes produced through the screen printing with the distance between substrate and screen as 0 mm (top) and 1 mm (bottom), respectively;

FIG. 7 is a photograph (top) and SEM image (bottom) of 3-layered graphite anode produced through a screen printing method;

FIG. 8 depicts photographs of printed graphite anodes with various pore distances before and after a 3 point bending test;

FIG. 9 depicts cyclability of LIBs with 1- and 3-layered graphite electrodes;

FIG. 10 is SEM images of cycled 1- (top) and 3- (bottom) layered graphite electrodes;

FIG. 11 shows XRD (up) and Raman spectroscopies (bottom) of cycled graphite electrodes with various state of charge (SOCs);

FIG. 12 shows the simulation domain of non-porous graphite/Li cell in COMSOL (up). The comparison of voltage profiles (below) between theoretical predictions (dash lines) and experimental measurements (doted lines) to validate the established model;

FIG. 13 is a schematic illustration of cells with 1-layered graphite electrode with uniform porosity and 3-layered graphite electrode with gradient porosity (up, left) used for simulation; the simulation domain of graphite electrode (below, left) with the thickness of 100 μm and vertically aligned pore channels. The simulated results suggest that smaller channel separation can decrease potential gradient through thickness (through plane, below, middle) and between pores (in plane, below, right);

FIG. 14 depicts the simulated capacities of cells with non-porous graphite electrodes with different thicknesses (up, left) and printed electrodes with patterned pores (below, left) at plating threshold; The capacity at plating threshold comparison between analytical solution (dashed curves) and experimental results (symbols) for conventional (up, right) and printed (up, right) graphite electrodes;

FIG. 15 depicts the illustrated experiment setup (left) of multi-beam optical sensor (MOSS) and photographs of cell configuration used in MOSS. The stress evolution in graphite electrode along the lithiation/delithaition process, which was collected from MOSS;

FIG. 16 shows designed patterns for printed electrodes with controllable pore diameter and/or edge-to-edge (E2E) pore distance; the designed screen template with the same E2E pore distance of 2 mm and different pore diameters (top), and the same pore diameter of 100 μm and various E2E pore distances (middle). Photographs (bottom) of fabricated screen templates for printing patterned electrodes with different pore diameters and E2E pore;

FIG. 17 shows photographs of patterned electrodes printed at the speed of 11 inch/second and with the snap-off distances of 20 (left column), 30 (middle column) and 45 (right column); all printed electrodes had the same pore diameter of 100 μm and E2E pore distances of 200 μm (top row), 300 μm (middle row) and 400 μm (bottom row).

FIG. 18 shows photographs of printed graphite electrodes with the same pore diameter of 100 μm and varied E2E pore distances by using inks with different solid contents. The red scale bar represents 500 μm, while 200 μm for green scale bar;

FIG. 19 shows photographs of printed graphite electrodes after 3- and 4-point and twist tests;

FIG. 20 depicts photographs of 4-layered graphite anodes with the designed pore diameter of 100 μm and E2E pore distances of 200, 300 and 400 μm respectively (top). Microscope images of printed graphite electrodes with pore diameter of 100 μm and E2E pore distances of 400 μm (lower left, up) and 200 μm (lower left, bottom). The microscope images (lower right) clearly show that the printed electrodes have actual pore diameter is ˜100 m and E2E pore distance of ˜200 μm;

FIG. 21 shows the rate capability (top) and cycling performance (bottom) of full cells with printed graphite anodes and bar coated NMC622 cathode;

FIG. 22 shows SEM images (top) of membrane separators with various thicknesses and porosities (the separator numbers are same as those in Table 2), and rate capacities (bottom) of Li/graphite half cells with different separator;

FIG. 23 shows the assembly process (top) of SLP cells with NMC622 cathodes and printed graphite anodes. Photographs of six (6), 20 mAh SLP cells with printed graphite anodes (bottom) built using this process;

FIG. 24 shows the voltage profiles (top left), specific capacity and ICL of two representative SLP cells;

FIG. 25 shows photographs of 45 representative 1.5 Ah baseline pouch cells assembled with NCM622 cathode and Mage-3 graphite anode during Budget Period 2. The experiment set up for dynamic impact test (bottom, left) and photos (bottom, right) of cells after the dynamic impact test.

### DETAILED DESCRIPTION

With the promise of low cost, high rate and yield, R2R processing has been widely adopted by manufacturers to produce electrodes for commercial LIBs. The cost of battery packs containing electrodes fabricated with SOA R2R process was still $176/kWh in 2018. To enable the widespread adoption of LIBs for transport, grid storage, and other applications, additional advances in electrode manufacturing processes are required to further reduce battery pack cost. Furthermore, it is a challenge to employ the current SOA R2R processes to fabricate electrodes with precisely controlled porous architectures, which are crucial for fast charging cells.

Fast charging requires electrodes with high porosity and low tortuosity to enable fast electrolyte transport but also prevent lithium plating. Though SOA R2R processes could effectively produce electrodes with exclusive high porosity throughout an electrode to meet the requirement for fast charging, this always results in energy reduction and cost enhancement in cells.

We overcame the aforementioned drawbacks by developing a novel printing process for high volume electrode production with precisely controlled electrode architecture.

This novel electrode manufacturing process closely follows a well-established process from the printing industry and can employ flexography, rotogravure, screen or inkjet printing processes. The porosity of each laminar deposition may be controlled by varying the solid content and/or viscosity of the coating slurries (inks). In addition, various patterns with vertically aligned pores may be generated in the electrodes (patterned electrodes) by using the patterned rolls.

The electrodes produced through this novel printing process have varied porosities along the thickness direction, and if necessary, patterns through the electrode could be created simultaneously.

Advantages of electrodes produced through this novel printing process are expected for four reasons: (1) high Li-ion diffusion enabled by the porous architecture; (2) high loading of active materials due to varied porosity along the thickness direction; (3) low tortuosity due to the patterned structure; and (4) low cost due to the high throughput nature of the printing process.

### Differences Over the Prior Art

With the promise of low cost, multiple geometries and fast fabrication, various printing processes have been used to print electrodes for LIBs. For instance, screen and inkjet printing have been used to print anodes. Flexography and gravure have been used to print cathodes. Three-dimensional printing processes were used to fabricate LiFePO₄ (LFP) electrodes with ultrahigh rate. The primary advantage of using printing processes to manufacture LIBs is being able to deposit active materials in specific patterns. This would enable printed electrodes with predefined porous architectures to facilitate the transportation of lithium ions. Electrodes manufactured through printing processes are also customizable, thin, light, low cost, flexible and suitable for low currents. These characteristics make printed electrodes attractive in applications such as radio frequency identification (RFID) devices, smart cards, sensors and wearable and medical devices, which have a low requirement on both current and energy density of batteries.

Printed electrodes have not been developed with heed to addressing Li plating in fast charging batteries for electrical vehicles (EVs), however. Fast charging battery developers have been pursuing two basic approaches to alleviate Li plating in the electrodes at high current density. The prevalent strategy is the development of structured electrodes designed to provide paths for fast electrolyte transport and reduce the tortuosity of electrodes in the first place. Examples of these electrodes include spatially ordered macroporous structures (Sakamoto, J. S.; Dunn, B., J Mater Chem 2002, 12, 2859-2861), three-dimensional bi-continuous nanoarchitecture (Zhang, H. G.; Yu, X. D.; Braun, P. V., Nat Nanotechnol 2011, 6, 277-281.), multimodal/hierarchical pore size distribution (Fang, B.; Kim, M. S.; Kim, J. H., et al., J Mater Chem 2010, 20, 10253-10259) and dual-scale porosity distribution (Delattre, B.; Amin, R.; Sander, J., et al., J Electrochem Soc 2018, 165, A388-A395; Bae, C. J.; Erdonmez, C. K.; Halloran, J. W., et al., Adv Mater 2013, 25, 1254-1258.) A recent proposal has proposed a co-extrusion electrode with alternatively arranged high porosity and dense regions for high-power batteries (Cobb, C. L., 2016 Annual Merit Review 2016 June 9. Cobb, C. L., 2016 AIChE Annual Meeting 2016 November 14). The low tortuosity in these structured electrodes effectively suppresses Li plating, but this high porosity results in significantly reduced mass loading and ultimately a low capacity in the electrodes. This greatly limits structured electrode applications in electrical vehicles (EVs), for which high energy density is also one of the most important criteria for practical utilization. Therefore, there is a need to fabricate a structured electrode with high capacity and preserve low tortuosity.

An alternative and effective approach to alleviate Li plating is to employ electrodes with gradient porosity in fast charging batteries with high energy density. Results from theoretical computation (Suthar, B.; Northrop, P. W. C.; Rife, D., et al., J Electrochem Soc 2015, 162, A1708-A1717) corroborated by experimental evidence (Yao, K. P. C.; Okasinski, J. S.; Kalaga, K., et al., Energ Environ Sci 2019, 12, 656-665) shows that, under certain charging conditions, a steep concentration gradient of Li content develops across the graphite anode with isotropic porosity: more lithium present near the surface (interface between anode and separator) than at the back (current collector), with the concentration of lithium exponentially falling towards the current collector (Yao et al. 2019). When charging at high rates, Li plating will occur near the surface of electrode (Kim, N.; Chae, S.; Ma, J., et al., Nat Commun 2017), if the concentration of accumulated lithium ions is saturated (Liu, Q. Q.; Du, C. Y.; Shen, B., et al., Rsc Adv 2016, 6, 88683-88700).

This suggests that Li plating is severely affected by the porosity/tortuosity at the electrode/separator interface. In other words, a gradient porosity with higher porosity near the electrode/separator interface could effectively alleviate Li plating without significantly reducing the capacity of the electrode. However, the manufacturing difficulty of forming gradient porosity limits the practical application of these electrodes in fast charging batteries.

The systems, methods and electrodes of the present disclosure provide the following to overcome the problems identified in the prior art:
High capacity and low tortuosity near electrode/separator interface from gradient porosity
Further reduced tortuosity due to the patterned pores

In addition to their structural property advantages, the discussed electrodes will also benefit from compatibility with high volume R2R printing process. The high throughput nature of the printing process should significantly reduce the cost of manufactured electrodes and further reduce the battery pack cost to an estimated $80/kWh for wide applications. More importantly, the high flexibility of printing process makes precisely building multilayer configurations in an individual electrode an easy process, which is crucial in manufacturing electrodes for fast charging batteries.

### Printing Processes.

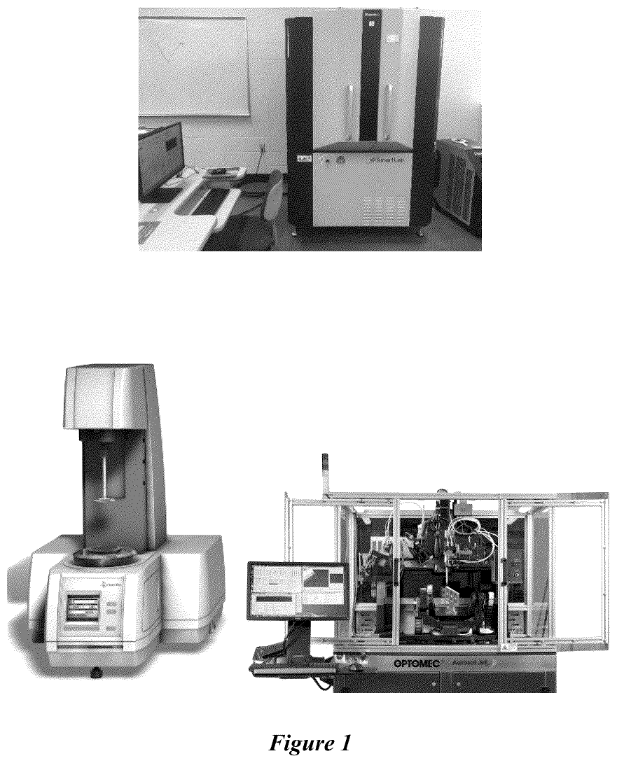

An array of printing processes is available for printing electrodes, including inkjet, screen, gravure and flexography. FIG. 1 shows a representative aerosol ink jet printer used to fabricate some of the example embodiments below

### Ink Formulations

The key to the success of printable LMB electrodes has been ink formulations. Using cellulose nanofiber (CNF), as well as tuning the solid content, effectively improves the viscosity of ink and dispersion of LFP powders to print robust cathodes with a desirable porous structure to suppress Li dendrite formation. The rheological (flow) properties of the ink are crucial to quality control necessary to achieve this reproducibility. The rheology of inks depends on particle size, solid loading, and solvent type, and can be optimized to ensure reliable flow, promote adhesion between each printed layer and mechanical stability, provide structural integrity and avoid cracking during the drying process. In addition, viscosity and surface tension of inks can also be tailored for a specific printing technology, and the processing shear rate has to be tailored to prevent the agglomeration or sedimentation of the particles. These processes and previously learned knowledge has been adopted to develop new printable inks with various active materials.

### Anode Inks

As noted above, inks are keys to the success of printing electrodes, and the quality of printed electrodes greatly depend on the rheological properties of inks, which are determined by the ink formula and the properties of ink components. In some embodiments, anode inks include graphite as active material, carbon black as conductive additive, polyvinylidene difluoride (PVDF) as binder and N-Methyl-2-Pyrrolidone (NMP) as the solvent.

Various graphite powders may be used, including MAGE MAGE3, P66, P5, P10, P15, T16 etc., and down select P5 and T16 with optimized composition, viscosity, etc. In some embodiments, Phillips 66 graphite may be used as the active material.

A broad range of binders (polyvinylpyrrolidone (PVP), polyacrylic acid (PAA), polyvinylidene difluoride (PVDF), carboxymethyl cellulose (CMC), styrene butadiene rubber (SBR)) and solvents (N-methyl-2-pyrrolidone (NMP), water, ethylene glycol acetate, isopropyl, and ethanol) may also be used in some embodiments.

Key variables, such as the particle size, particle morphology, ink formulation (viscosity and surface tension) and processing conditions (disperse method, mixed speed, temperature and time) may affect the properties of an ink. To meet high energy and fast charging requirements on EV batteries, advanced materials with high capacity and high ionic conductivity, such as silicon-containing composites and LTO, have also been utilized to prepare printable anode inks.

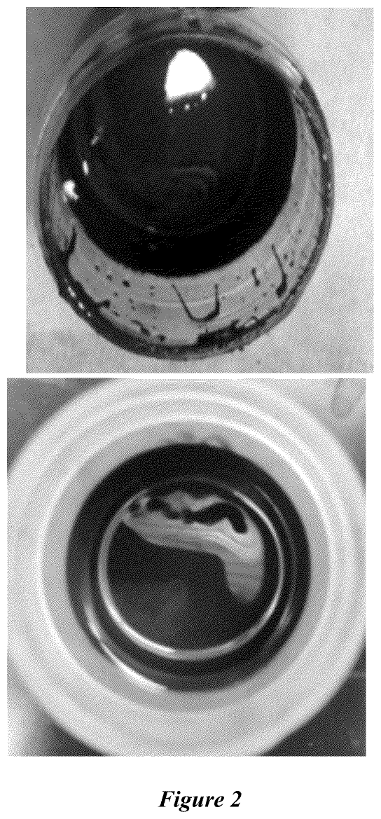

In some embodiments and aspects, an NMP-based anode ink is used comprising 92% Phillips 66 graphite, 2% carbon black and 6% Kureha 9100 PVDF suitable for screen printing (see, e.g. FIG. 2, bottom). FIG. 2 (top) shows an electrode printed with the same ink composition, except MAGE3 was used instead, showing a less-uniform printing.

In some embodiments, the ink may have a viscosity zone of between 900-3000 Paos, for suitability for screen printing. Viscosity of inks strongly depends on the particle size of graphite; the bigger the graphite particle, the lower the ink viscosity. The viscosity of ink also increases along with the solid content. Thus, the printability is significantly influenced by the particle size of graphite and the viscosity of inks.

### Cathode Inks

Cathode inks were prepared with a focus on LiNixCo1−x−yMnyO2 (NCM) as active material, carbon black as conductive additive, polyvinylidene difluoride (PVDF) as binder and N-Methyl-2-Pyrrolidone (NMP) as the solvent. To meet the high energy and fast charging requirements for electrical vehicle batteries, other cathode materials including LiFePO4 and Li2CoO3 can also be utilized to prepare printable cathode inks. A broad range of binders (PVDFs with a variety of molecular weight and CMC/SBR) and solvents (water, isopropyl, ethanol and their mixtures) made be used to prepare inks with desirable properties for printing processes.

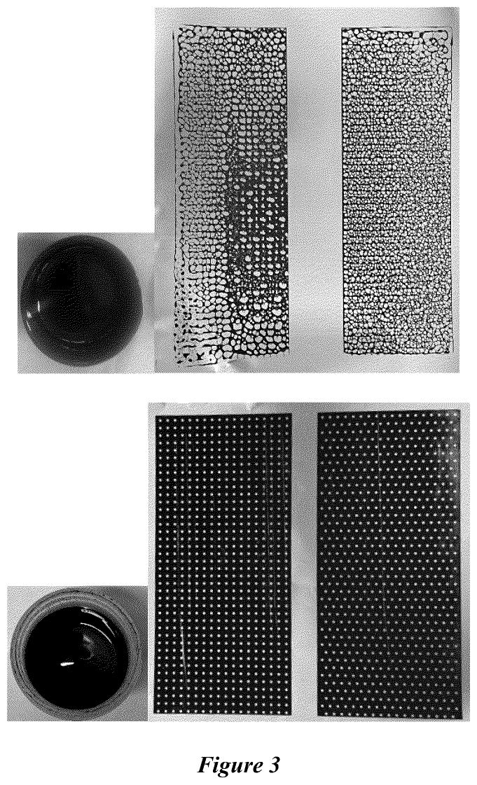

Some aspects and embodiments include an NMP-based cathode ink composed of 94% NCM622, 4% carbon black and 2% PVDF, and with a solid content of 70%, this ink demonstrated excellent printability (FIG. 3). Further, we developed another NMP-based cathode ink with LiNi_{0.8}Co_{0.1}Mn_{0.1}O₂(NCM811) and it showed excellent printability when the solid content is 65%. The viscosity of cathode inks appears to be not significantly influenced by the type of binder and carbon black. However, the printability of cathode is affected by the viscosity of inks and active materials.

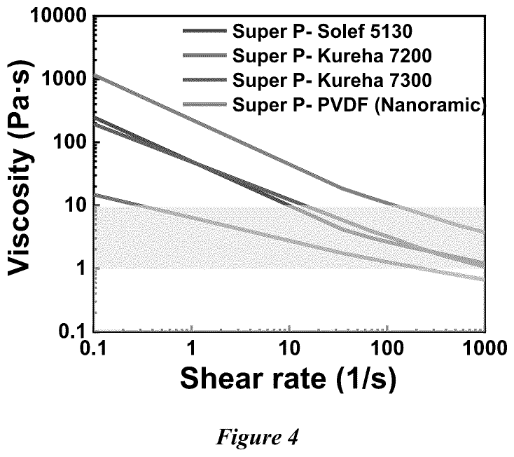

FIG. 3 shows examples of screen-printed cathodes from NMP-based inks with solid content of 50% (top) and 70% (bottom). The template designed for 1 mm pores was used for both printed cathodes. Both inks were composed of 94% NCM622, 4% carbon black and 2% Solvay 5130 PVDF. The solid content of inks for both printed electrodes was 60%. FIG. 4 shows the rheology of NMP-based anode inks used for printed electrodes. All anode inks were composed of 94% graphite, 2% carbon black and 6% PVDF binders. The solid content of all cathode inks was 50% for all anode inks.

### Printing Electrodes

LIB negative and positive electrodes were fabricated using screen, flexographic, gravure, and aerosol jet printing, and printability with different printing processes was evaluated, including ink properties (components and formula) and printing conditions (printing speed, pressure, squeegee type, distance between screen and substrate). Electrodes with controlled porous structure and varied loading of active materials were printed.

In some embodiments, screen printing is used to print electrodes; other techniques may be suitable for other applications.

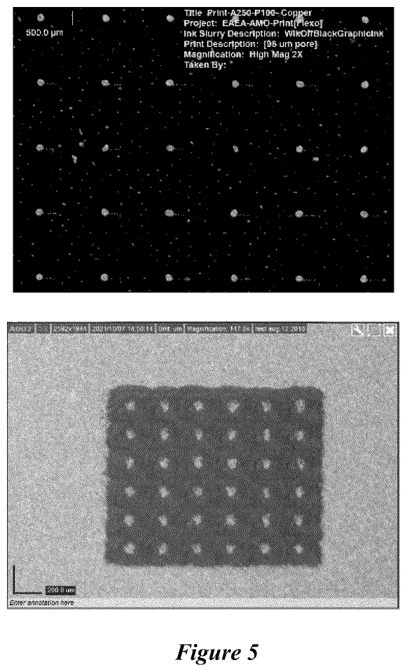

Example 1. In this example, patterned electrodes were printed using flexographic, gravure, screen and aerosol jet printing techniques. To meet specific requirements, inks were further developed suitable for flexo/gravure and aerosol jet printing processes. The properties of electrodes obtained from different printing techniques were evaluated in terms of printability, porous structure and mass/capacity loading. We found that the binder type and solid content have significant influence on the printability of evaluated printing methods. We developed an NMP-based graphite ink composed of 80% Phillips 66 graphite, 5% carbon black and 15% PVP for flexographic and gravure printings, which is appropriate for flexographic and gravure printing approaches. Controlling the solid content of the ink in a narrow range of 68%-72%, graphite anodes with secondary pore size of <300 μm were successfully printed with the current template design. The aerosol jet printing approach required inks with low viscosity of <100 Pas and particle size below 500 nm. We developed an aqueous ink composed of 70% Si, 10% carbon black, 10% Li-PAA and 10% PVP suitable for aerosol jet printing approach. With the 6% solid content ink, we fabricated a Si anode with excellent quality by using the aerosol jet printing method. Electrodes fabricated through various printing techniques are shown in FIG. 5 and Table 1 below. The Figure shows graphite anodes produced through the flexographic (left) method and Si anode produced through aerosol jet printing method (right). The inks used for flexographic and gravure printing (not shown) was composed of 80% Phillips 66 graphite, 5% carbon black and 15% PVP and had the solid content of 70%. The ink used for aerosol jet printing was composed of 70% Si, 10% carbon black, 10% Li-PAA and 10% PVP, and had a solid content of 6%. The average pore size was measured to be 50 μm for aerosol jet printed electrode.

Depending on the method applied, the properties of the printed electrodes varied and are summarized in Table 1. Based on the printability, we selected the screen printing technique for printing LIB electrodes at large scale, while flexo/gravure and aerosol jet printing are suitable for further electrode design in the future.

TABLE 1
Summary of anodes printed through various methods

| | Patterned pore size | Mass loading of |
|---|---|---|
| | (minimum pore size | electrode (one printing |
| Printing method | available currently, μm) | pass, mg/cm²⁾ |
| Screen | 90 | 2.5-5 |
| Flexographic | 70 | 1.5 |
| Gravure | 280 | 2.0 |
| Aerosol Jet | 50 | 0.7-1.0 |

In some embodiments, electrodes may be one or more layered, one-layered, two-layered, three layered, three or more layered. In some embodiments, electrodes are three layered. In some embodiments, each layer can be printed with different porosities in order to optimize the entire electrode for maximum capacity, with minimum loss of electrode/cell life due to Li-plating.

Example 2. Three-layered electrodes with P5 and T16 graphite and SEM observations on the cross section of three-layered electrodes clearly showed the bottom layer (contacted with Cu substrate) with the lowest porosity, middle layer with medium porosity and top layer with the highest porosity.

Using screen printing, we fabricated both anode cathode with patterned and straight pore channels. The printed pores could be controlled from 100 μm to 1000 μm through tuning the size of emulsion dots on the screen templates.

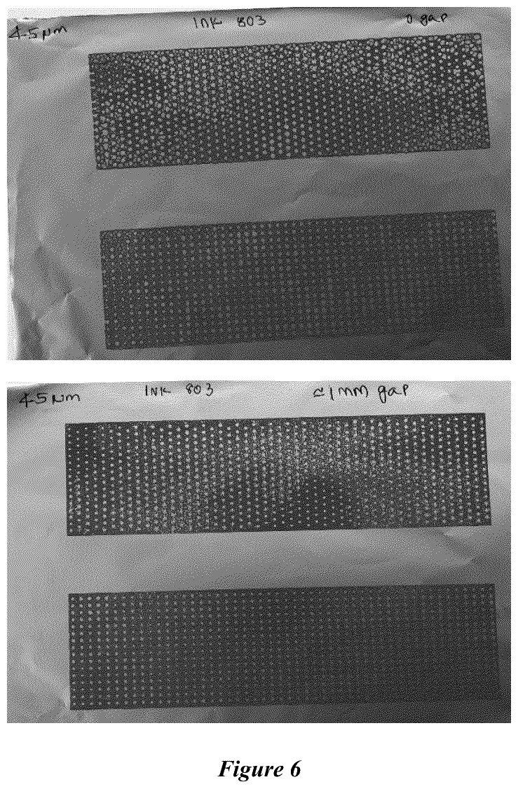

Example 3. In this example the influence of conditions of screen printing on the quality of printed electrodes was systematically investigated. With identified inks, designed and fabricated screen templates were designed with various pore diameters and alignments. The influence of screen materials, pore patterns and emulsion dot thickness on the printability was studied. The effect of printing speed, squeegee material, pressure applied to the squeegee, and gap between screen and substrate on the quality of printed electrodes was also investigated. FIG. 6 shows that a 1 mm gap between substrate and screen resulted in printed electrodes with excellent quality. The figure shows graphite anodes produced through the screen printing with the distance between substrate and screen as 0 (left) and 1 (right) mm respectively. The inks for both printed electrodes were composed of 92% graphite, 2% carbon black and 6% PVDF and had the solid content of 60%. The designed pore diameter for both electrodes was 1 mm.

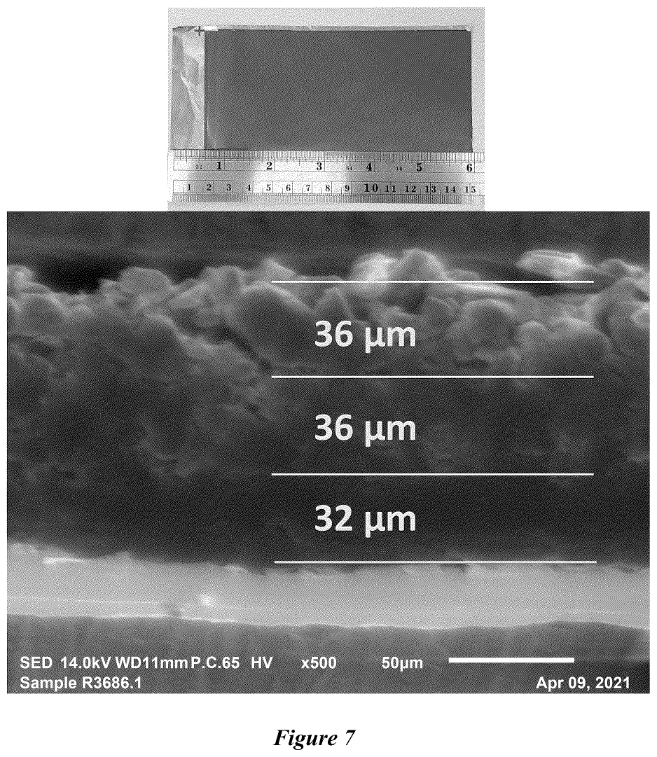

Example 4. In this example, multiple laminar depositions on the substrate were successfully deposited. Two approaches to print 3-layered graphite anode with varied porosity were developed. One was to print each electrode layer using inks with different solid contents and then calender the 3-layered electrode (3P1C). The other was to print each electrode layer with the same ink, but each electrode layer was calendered to various thickness with different porosity (3P3C). FIG. 7 shows that a 15 cm×6 cm graphite with porosity varied along the thickness direction was successfully produced through the 3P3C approach with bottom layer (L1) exhibiting the lowest porosity and highest porosity for top layer (L3). FIG. 7 shows a photograph (top) and SEM image (bottom) of three-layered graphite anode produced through screen printing method. The SEM image clearly shows that the porosity increases from bottom layer (L1) to top layer (L3). The calculated overall porosity of graphite electrode is ˜30% with ˜20% for L1, 30% for L2 and 40% for L3. The mass loading of 3-layered graphite anode is ˜12 mg/cm².

Example 5. Here, a single laminar deposition was made on the substrate. Using a screen printing method, 15 cm×4 cm graphite anodes with patterned and straight pore channels were successfully produced. Tuning the size of emulsion dots on the screen template, the size of patterned pores could be controlled in the range of 100 μm to 1000 μm (e.g., 10, 500 and 1000 μm). The printed electrodes with smaller pattered pores demonstrated higher mass loading. Further, graphite electrodes with two porous patterns, one with straight-line and the other with staggered pore alignment, were also produced through the screen printing method.

### Three Layered Anode

Used as an anode, the printed 3-layered graphite electrode with porosity varied along the thickness direction demonstrated stable battery performance up to 2C, while 1C for the baseline commercial electrode with uniform porosity. The 3-layered graphite electrode also showed superiority in suppressing Li plating at high rate of 4C and durability over the baseline electrode.

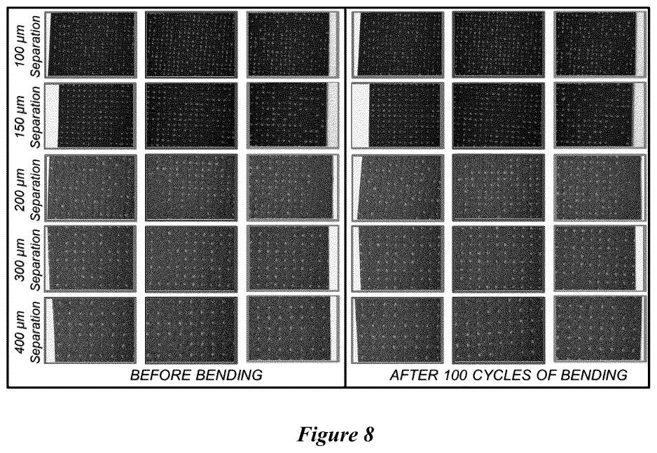

Example 6. In this example, we performed 3- and 4-point bending and twisting tests to evaluate the mechanical strength of printed electrodes. The uniformity, roughness and porosity before and after mechanical tests were evaluated by optical, electron and atomic force microscopes. For comparison, same mechanical tests were also applied to the baseline electrodes fabricated through bar coating method. FIG. 8 shows that no degradation or delamination are observed on printed electrodes after bending test (same for bar coated electrodes). This indicates that the printed electrodes have the robust structure comparable to that of electrodes fabricated through conventional approaches. FIG. 8 also shows photographs of printed graphite anodes with various pore distance before and after 3 point bending test. The designed pore size for all graphite electrode was 100 μm. The 50 mm bending radius, 100 bend cycles and dwell time were applied to the bending test on all electrodes.

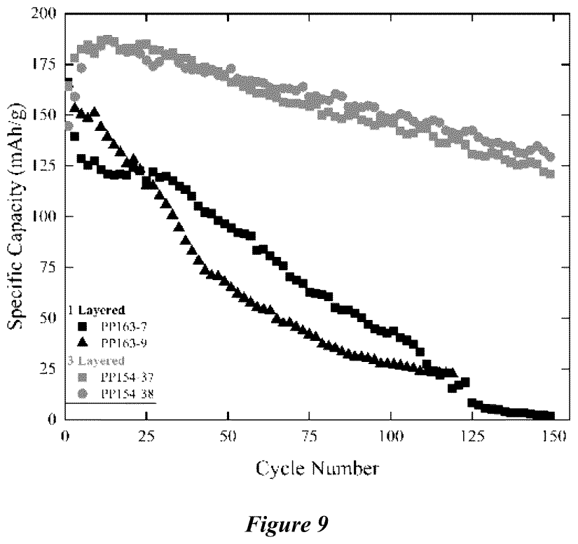

Example 7. The printed electrodes were assembled into coin cells with lithium metal foil as a counter electrode and tested in this example. Formation, rate and cycling tests were conducted to collect information about the specific capacity, rate capability and cycle life of printed electrodes. For comparison, the same approach was used to evaluate baseline electrodes produced through the bar coating method. FIG. 9 shows cyclability of LIBs with 1- and 3-layered graphite electrodes. The overall porosity of both 1- and 3-layered graphite electrodes was ˜30%. The 3-layered electrode has the bottom layer with porosity of ˜20%, 30% for middle layer and 40% for top layer, while same and isotropic porosity for 1-layered electrode. The current density applied to both 1- and 3-layered electrodes was 2C during cycling test. The mass loading of both 1- and 3-layered graphite anode is ˜9 mg/cm².

The 3-layer electrodes #2 and #4 had much less over-potential compared to other two 1-layer electrodes with 2C lithiation rate. This suggests that the 3-layered electrode with porosity varied along the thickness direction has the superior rate capability over the 1-layered electrode with isotropic porosity. Further, ˜80% capacity was retained in the 3-layered electrode after 120 cycles, while <80% capacity remained in the 1-layered electrodes after 30 cycles. This demonstrates the printed electrodes with >50% improvement in rate capability over SOA commercial electrodes.

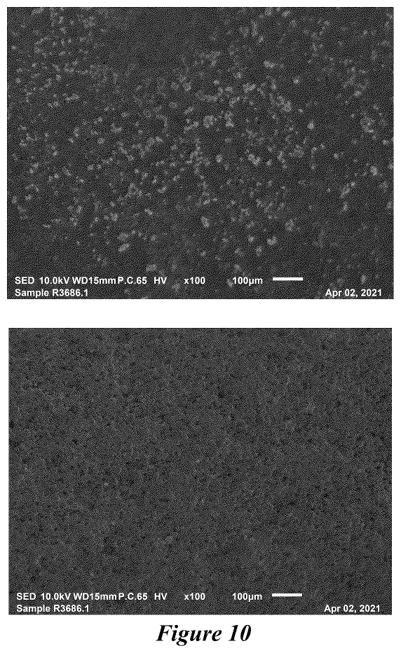

Example 8. The cycled cells with printed and baseline electrodes were disassembled, and the electrodes were cleaned and dried inside a glovebox. The harvested electrodes were characterized by XRD, SEM and TEM. FIG. 10 shows SEM images of cycled 1-(left) and 3- (right) layered graphite electrodes. The overall porosity of both 1- and 3-layered graphite electrodes was ˜30%. The 3-layered electrode has the bottom layer with porosity of ˜20%, 30% for middle layer and 40% for top layer, while same and isotropic porosity for 1-layered electrode. Both cycled electrodes for SEM observations were harvested from cells underwent rate capability test at 4C and under delithiated condition. The white particles in SEM were identified through EDS to be plated Li metal. The mass loading of both 1- and 3-layered graphite anode is ˜9 mg/cm². A larger number of white-colored particles could be observed on the surface of a 1-layered graphite electrode that underwent 4C rate test, while white particles barely observable on 3-layered electrode.

These white particles were identified as plated Li metal through the EDS analysis. This demonstrates the superiority of printed electrodes in suppressing the Li plating at high rates over conventional electrodes.

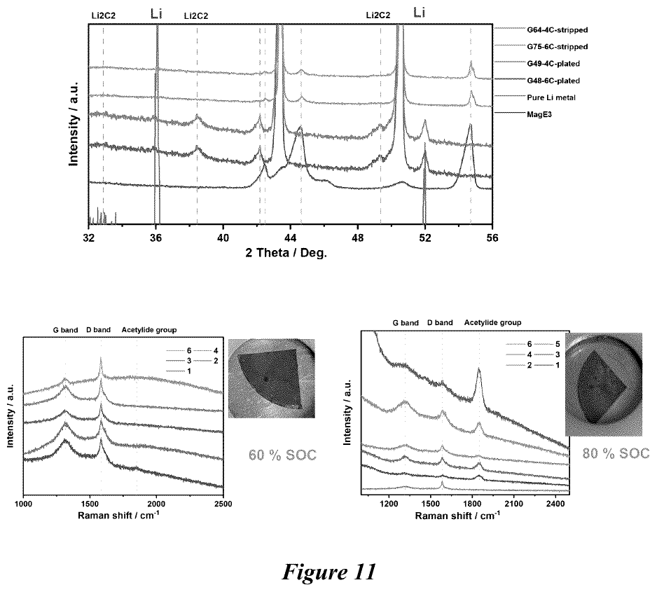

Example 9. To understand the effect of porous architectures on the mechanical degradation in electrodes, electrodes were printed on the quartz substrate with conductive coatings. The printed electrodes were assembled into cell. In-situ information about the mechanical properties of printed electrodes was collected based on electron microscopy of FIB cut cross-sections. Meanwhile, ex-situ measurements were also conducted to collect microstructure information of electrodes along the charge/discharge process. FIG. 11 shows XRD (up) and Raman spectroscopies (bottom) of cycled graphite electrodes with various state of charge (SOCs). All electrodes had the same formula of 92% graphite, 2% carbon black and 6% PVDF. The electrodes for Raman measurements were harvested from cells underwent 4C rate tests. For each sample, the Raman measurement was performed on six different locations.

FIG. 11 shows that Li metal can be found from the plated samples (both 4C and 6C) while disappeared at stripped conditions from XRD. In addition, acetylide species could be found from plated samples, which is confirmed from both XRD and Raman.

### Modelling of Porosity Structure

Example 10. Based on the physical and electrochemical properties of conventional graphite electrodes collected in the above examples, we constructed an initial model using 1D Newman model in COMSOL software. We calibrated this model using experimental results collected on a conventional graphite anode operated at a low current density of 0.01C with the voltage window of 10 mV-1.5V.

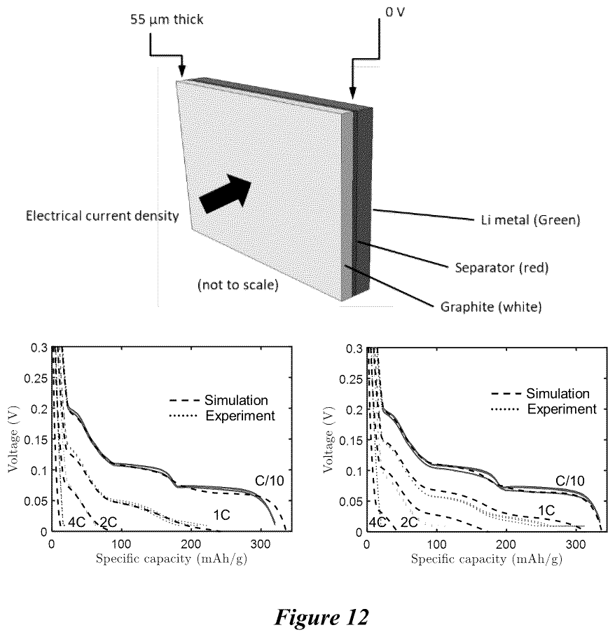

FIG. 12 shows the simulation domain of non-porous graphite/Li cell in COMSOL (up). The comparison of voltage profiles (below) between theoretical predictions (dash lines) and experimental measurements (dotted lines) to validate the established model. The theoretical model was firstly calibrated with experimental data collected on the 55 □m thick graphite electrode with the porosity of 35% at 0.01 C. The experimental data for model validation were collected on the 41 m thick (35% porosity, below, left) and 19 □m (22% porosity, below, right) graphite electrodes respectively. During electrochemical characterizations, the constant charge (delithiate) current density of C/3 was applied to all cells with the voltage window of 10 mV-1.5V. As shown in FIG. 12, the voltage profiles predicted from the established model perfectly match the experiments on graphite electrodes with different thicknesses and porosities.

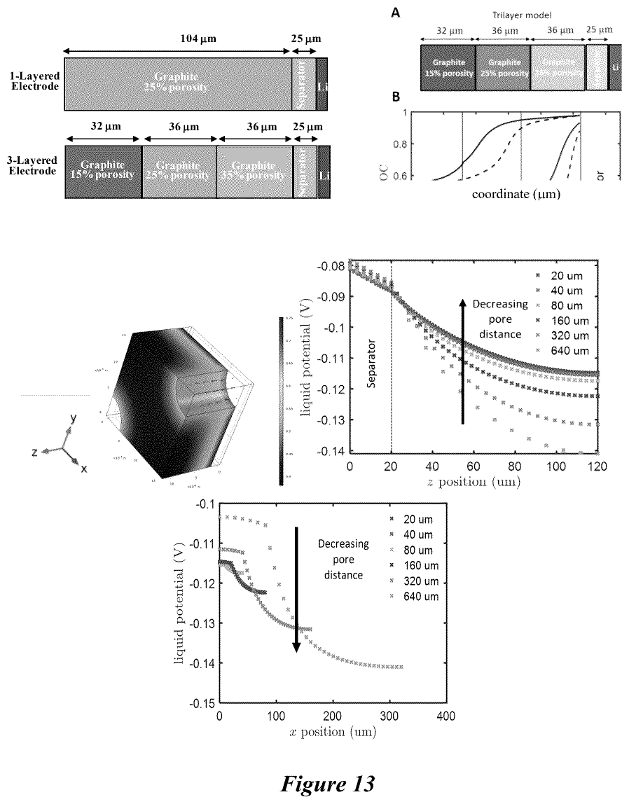

Example 11. The model established in Example 10 was expanded to investigate the electrochemical performance of electrodes with different porous structures, especially with gradient porosity and secondary porous network (SPN). We studied the Li-ion transport, local potentials of both liquid electrolyte and solid phases and local state-of-charge (SOC) in the graphite electrodes with various porous structure under fast charging operation. We successfully elucidated the relationship between the Li-plating mechanism and the local microstructure and the effect of gradient porosity/SNP on suppressing the Li plating in graphite electrodes, as shown in FIG. 13. Furthermore, we expanded this model to successfully predict the electrochemical behaviors of cathodes with gradient porosity and SPN.

FIG. 13 shows a schematic illustration of cells with 1-layered graphite electrode with uniform porosity and 3-layered graphite electrode with gradient porosity (up, left) used for simulation. At the plating threshold, the 3-layered electrode has the average local profiles above those of the 1-layered electrodes, indicating the higher capacity in 3-layered electrodes. The simulation domain of graphite electrode (below, left) with the thickness of 100 μm and vertically aligned pore channels. The simulated results suggest that smaller channel separation can decrease potential gradient through thickness (through plane, below, middle) and between pores (in plane, below, right)

Example 12. Using the model validated in Example 11, we calculated the capacity of cells when Li plating took place in the conventional graphite electrodes with various thicknesses and porosities at different discharge (lithiation) current densities. We also used this validated model to study the capacity at plating threshold of printed graphite electrodes with various porous architectures. The predicted capacities at plating threshold were compared with experimental results. In further, we normalized the cell properties of the electrode thickness (L) and porosity (1-εs), ionic conductivity of electrolyte (k_{eff}) and max concentration of Li-ion (C⁰) and operating conditions of C rate (C) and effective “slope” of graphite OCV (K_{eff, Gr}) into an inhomogeneity parameter of λ and established a “master curve” to predict the cell capacity at plating threshold.

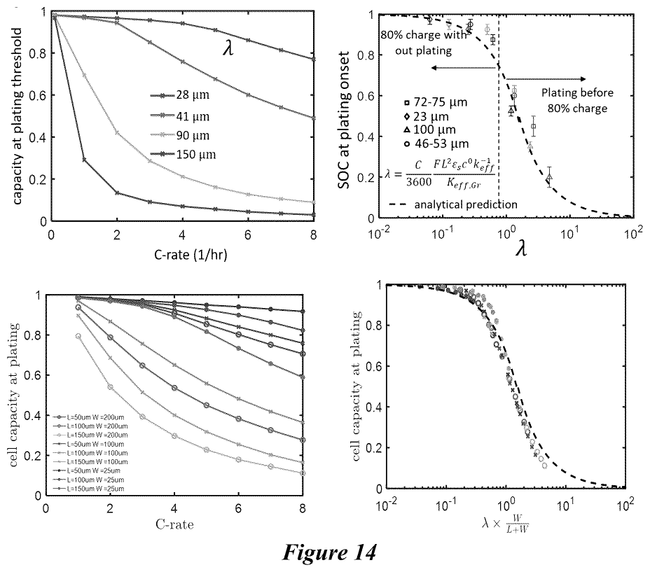

We successfully used this model to predict the Li plating in the graphite electrodes under various conditions. FIG. 14 shows the predicted capacities at plating threshold in conventional and printed graphite electrodes (FIG. 14, left), which were validated by experiments. All printed electrodes have the same pore diameter of 100 μm, and varied edge-to-edge distance (W) and thickness (L). In the presence of conventional graphite electrodes without SNP, the capacity at threshold predicted by the analytical solution matches the experimental results well (FIG. 14, up, right). Modified with the aspect ratio of SPN (W/(L+W)), the analytical solution predicted by this model fits the experimental measurements on printed electrodes with SPN well (FIG. 14, below, right). In addition, the simulated results show that the vertically aligned pore channels can significantly delay the onset of Li plating, compared with conventional graphite electrodes, under the same operation conditions. These achievements can be used to determine the electrode design and test protocol for graphite anodes to avoid the Li plating under fast charging applications.

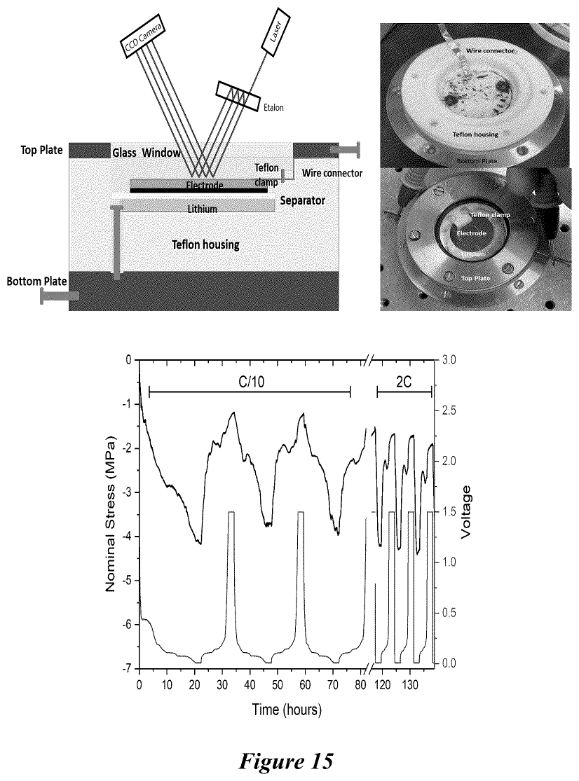

Example 13. In this Example, we expanded the model built in Example 12 to evaluate Si-containing electrodes, which will be used as advanced anodes to increase the energy density of final batteries. Information about the mechanical response of electrodes is critical input into the model. We used an equipment with multi-beam optical sensor (MOSS; see FIG. 15, left and center) to measure the curvature of the electrode under operating conditions, and initial trials with MOSS were conducted on graphite electrodes. A method has been developed to decode the curvature-to-stress relationship in the graphite electrodes. As shown in FIG. 15, MOSS shows significant compressive stress induced by the lithiation in the graphite electrodes and the effect current density on the stresses in the electrodes.

Example 14. In this task, we scaled up the ink preparation and printing process for fabricating patterned electrodes at large scale. We also optimized the inks and processes to print the electrodes. The mechanical properties of printed electrodes were evaluated via both simulation and experiments. At the end of this task, we increased printing speed to reach a targeted throughput of 2 m²/min. The ink and printing process were optimized. We also printed and evaluated the electrodes with optimal porous structures for fast charging applications.

We successfully printed electrodes with P5 and T16 graphite at the speed of 11 inch/sec (equal to a throughput of 2.5 m²/min with the print width of 6 inch) and observations from microscope confirmed that an optimal structure of pore diameter of 100 μm and E2E pore distance of 200 μm was produced in the printed electrode.

Example 15. The same approaches were used to print patterned NMC811 cathodes and Si-containing anodes. The results from the electrochemical characterizations exhibited printed NMC cathodes with the capacity of >180 mAh/g and >1000 mAh/g for Si-containing anodes. With the same mass loadings as NMC622 cathodes and graphite anodes, the cells with printed NMC811 cathodes and Si-containing anodes have the specific energy density of >275 Wh/kg.

Example 16. The printed graphite electrode with the pore diameter of 100 μm and E2E pore distance of 200 μm was used as anodes of LIBs. Coupled with bar coated NMC622 cathode, the full cells with printed graphite anode demonstrated the capacity retention of >80% at 4C and 6C.

Example 17. In this Example, we used Adobe® illustrator software to design the patterns (images) on the screen template. Depending on the printing process, the appropriate image carriers were fabricated through corresponding vendors. The variety of patterned templates was used to generate patterned pores in printed electrodes.

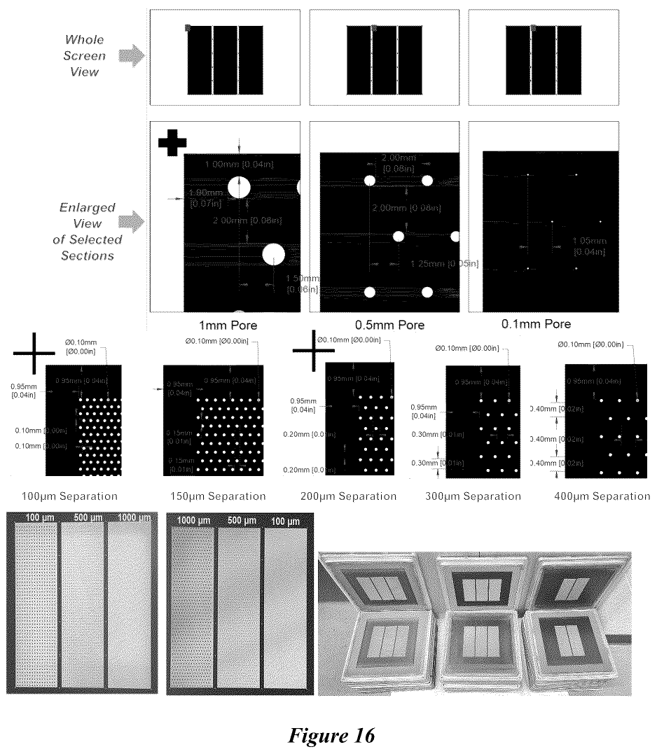

FIG. 16 shows designed patterns for printed electrodes with controllable pore diameter and/or edge-to-edge (E2E) pore distance; the designed screen template with the same E2E pore distance of 2 mm and different pore diameters (top), and the same pore diameter of 100 μm and various E2E pore distances (middle). Photographs (bottom) of fabricated screen templates for printing patterned electrodes with different pore diameters and E2E pore

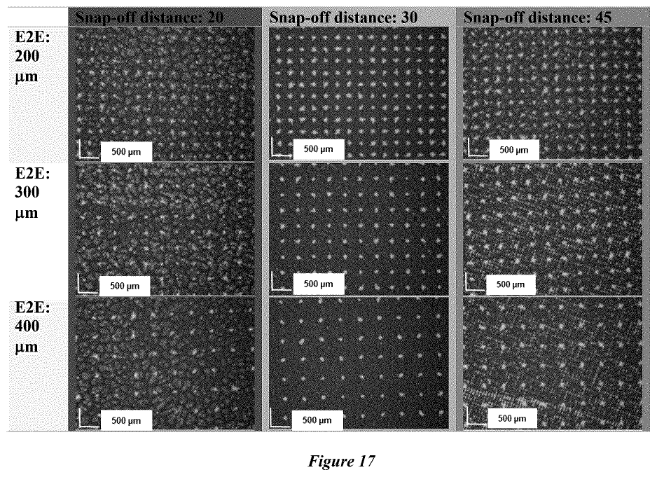

Example 18: In this Example, we prepared inks with various solid contents, fabricated screen templates with different patterns, printed electrodes at a variety of conditions, evaluated the quality of printed electrodes. We found that the ink solid content, snap-off distance between screen template and substrate and printing speed are key variables that control the quality of printed electrodes. We optimized the ink formula and printing parameters for printed electrodes with desirable porous structures. We also increased the printing speed to 11 inch/sec (equal to the throughput of 2.5 m²/min with the print width of 6 inch) and identified ink formula and snap-off distance for manufacturing electrodes with optimized porous structure at this printing speed. FIG. 17 shows photographs of patterned electrodes printed at the speed of 11 inch/second and with the snap-off distances of 20 (left column), 30 (middle column) and 45 (right column). The same graphite ink with 60% solid content was for all electrode printing. All printed electrodes had the same pore diameter of 100 of μm and E2E pore distances of 200 μm (top row), 300 μm (middle row) and 400 μm (bottom row).

This figure demonstrates the effect of snap-off distance on the quality of patterned electrodes printed at 11 inch/sec. Using the ink with the solid content of 60%, the printed electrodes exhibited excellent quality clearly showing the designed porous structure of 100 μm pore, when the snap-off distance was 30. In addition, we identified the suitable range of snap-off distance (25-35) for electrodes with excellent printing quality, when the solid content of ink is 60% and the printing speed is 11 inch/sec.

Example 19. In this Example, we printed electrodes with varied pore diameters and E2E pore distances using identified inks and optimized printing conditions. The effect of porous structure, including the pore diameter, E2E pore distance and pore alignment on the quality and mechanical strength of printed electrodes were evaluated through theoretical models and experiments. Based on experimental and simulated results, we optimized porous structure of printed electrodes.

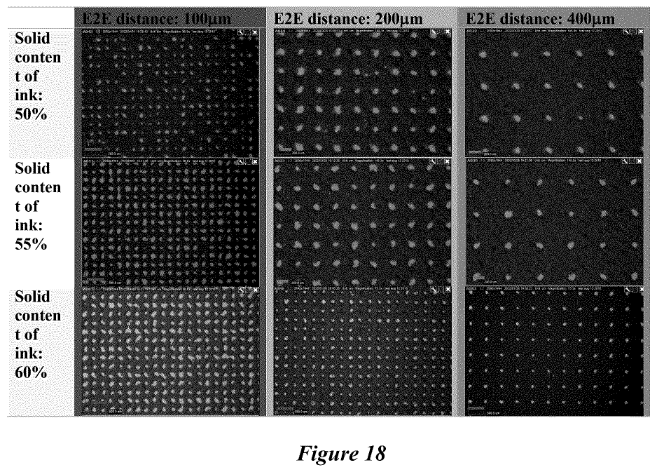

We optimized the porous structure of the electrodes in terms of printing quality, mechanical strength and the electrochemical performance, and printed the electrodes with the identified porous structure under the optimal printing conditions for fast charging batteries. FIG. 18 shows photographs of printed graphite electrodes with the same pore diameter of 100 μm and varied E2E pore distances (100 μm to 400 μm) by using inks with different solid contents. The red scale bar represents 500 μm, while 200 μm for green scale bar. All electrodes were printed at 11 inch/sec and the snap-off distance was 30.

The figure clearly shows that the electrodes with 100 μm pores and >200 μm E2E pore distance have excellent printing qualities, regardless of the solid content of inks

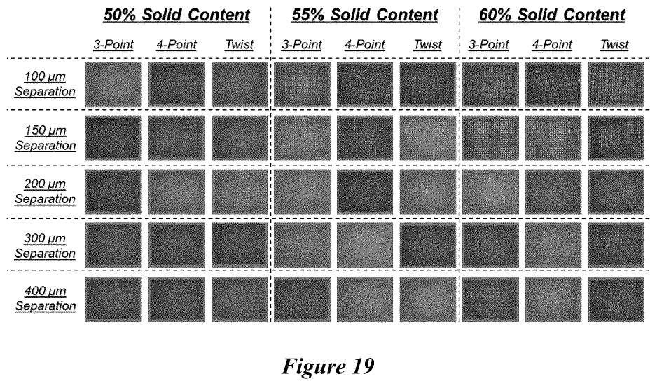

FIG. 19 shows photographs of printed graphite electrodes after 3- and 4-point and twist tests. All printed electrodes have the same pore diameter of 100 μm and E2E pore distance (separation) varied from 100 μm to 400 μm. All electrodes were printed at 11 inch/sec. FIG. 19 demonstrates the robust structure of all electrodes with 100 μm pores and E2E pore distance varied in the range of 100-400 μm.

Combined theoretical predictions from the Examples above, printing quality as seen in FIG. 18 and mechanical strength results seen in FIG. 19, we selected the electrode with 100 μm pores and 200 μm E2E pore distance for fast charging batteries.

Example 20. In this Example, we evaluated the physical properties of printed electrodes. The printed electrodes were cut into disks and evaluated as half cells using lithium metal as counter electrodes. Coupled with bar coated cathodes/anodes, the printed electrodes were also evaluated as full cells at coin cell and/or SLP cell levels. All cells underwent formation, rate and cycling tests.

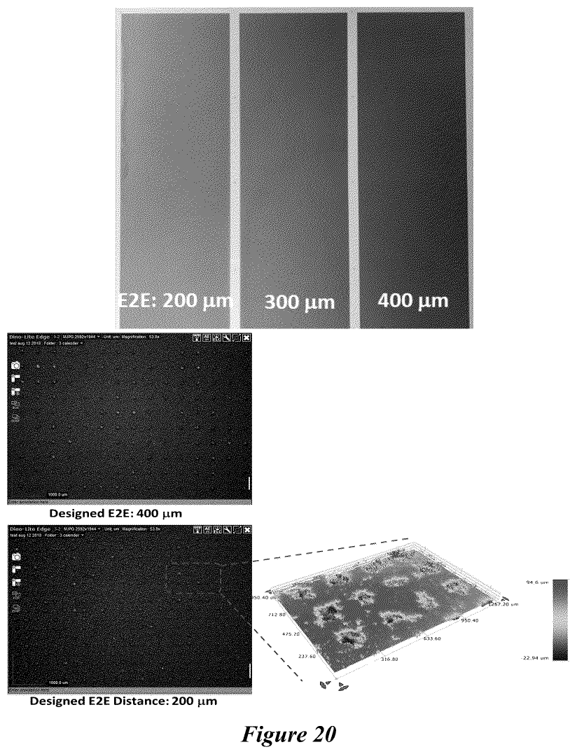

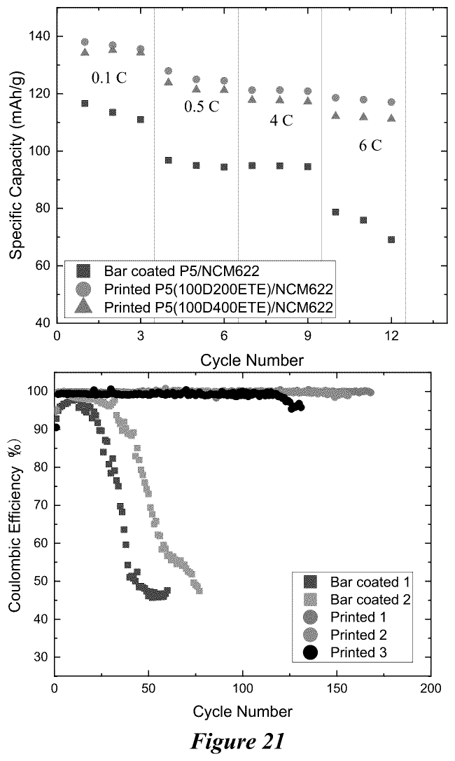

We demonstrated the specific capacity of >180 mAh/g from printed NMC 811 cathode and >1000 mAh/g from printed anodes containing Si. This suggested that the energy density of >275 Wh/kg can be achieved in the cells with printed electrodes containing advanced cathodes and anodes. We also showed full cells containing bar coated NMC622 cathode and printed graphite anode with the capacity of >80% at 4C and 6C (FIGS. 20 and 21). In addition, full cells with printed graphite anodes exhibited significantly improved durability, compared with those conventional cathodes and anodes.

FIG. 20 shows photographs of 4-layered graphite anodes with the designed pore diameter of 100 μm and E2E pore distances of 200, 300 and 400 μm respectively (top). Microscope images of printed graphite electrodes with pore diameter of 100 μm and E2E pore distances of 400 μm (lower left, up) and 200 μm (lower left, bottom). All electrodes were printed at 11 inch/sec using the ink with the solid content of 60%. The same printed process was conducted 4 times to fabricate 4-layered graphite electrodes. The microscope images clearly show that the printed electrodes have actual pore diameter is ˜100 m and E2E pore distance of ˜200 μm (lower right). The printed electrodes have the mass loading of 6.6-7.3 mg/cm².

FIG. 21 shows the rate capability (left) and cycling performance (right) of full cells with printed graphite anodes and bar coated NMC622 cathode. The printed graphite electrodes shown in FIG. 20 with 100 μm pores and 200 μm E2E pore distance, were used as anodes here. All cells had the same N/P ratio of ˜1.1. At 0.1C, all cells were tested with the voltage window of 3-4.25 V, while the voltage window of 3-4.15V was applied to 0.5, 4 and 6C. For cycling test, all cells were discharged to 3 V at C/3 and charged to 80% SOC at 2C without controlling the cut-off voltage.

Example 21. In this example, we initialized the design and assembly of pouch cells. Cell components, including the electrolyte, separator, tab and pouch materials were screened. At the end of this task, ˜29 mAh pouch cells were produced and tested. Cell components for large format cell assembly were validated.

Coupled with bar coated NMC622 cathodes, the printed graphite anodes produced in above were assembled into SLP cells. We built at least 6 SLP cells with printed graphite anodes. The results from electrochemical characterization demonstrated that the assembled SLP cells have the actual capacities of ˜29 mAh.

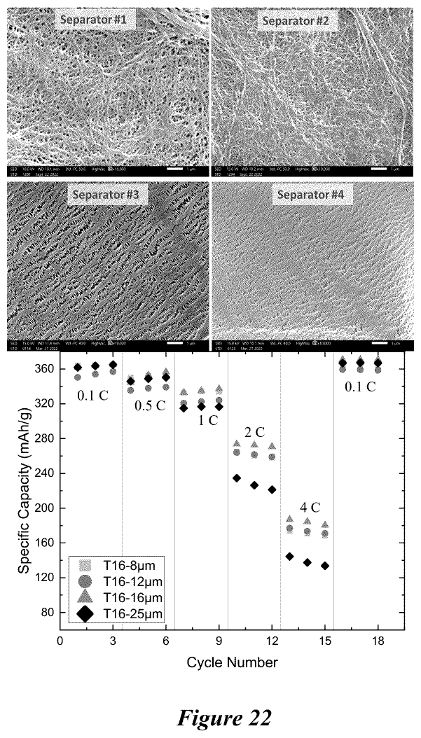

Example 22. In this Example, we sought the membrane separators with various thickness and porosities provided different suppliers. The secured separators were evaluated through electron microscopy and electrochemical characterizations at coin cell level. We also screened the tabs and pouch materials for SLP cell assembly. Table 2 shows 4 representative separators with different thickness and porosities secured and evaluated in this subtask. FIG. 22 demonstrates the porous structure of these separators and their rate capabilities.

TABLE 2
Information of membrane separators for fast charging batteries

| Separator | Description | Thickness (μm) | Porosity (%) |
|---|---|---|---|
| 1 | Microporous | 8 | 40 |
| | membrane (PE) | | |
| 2 | Microporous | 12 | 40 |
| | membrane (PE) | | |
| 3 | Microporous | 16 | 44 |
| | membrane | | |
| | (PP/PE/PP) | | |
| 4 | Microporous | 25 | 39 |
| | membrane | | |
| | (PP/PE/PP) | | |

Note:
PE—Polyethylene;
PP—Polypropylene

FIG. 22 shows SEM images (left) of membrane separators with various thicknesses and porosities (the separator numbers are same as those in Table 4), and rate capacities (right) of Li/graphite half cells with different separators. The bar coated graphite electrodes used here have the mass loading of ˜6.7 mg/cm² and porosity of ˜35%. During rate capability test, the constant current density of C/3 was applied to charge (delithiate) cells to 1.5V. An incremental current density (C/10, C/2, 1C, 2C and 4C) was applied to discharge (lithiate) cells to 10 mV and then hold at 10 mV until the current density was <C/20 or the total discharge time reached a time corresponded to the rate. At each rate, cells underwent three cycles.

Example 23. In this Example, more than six SLP cells were assembled with bar coated NMC622 cathodes and printed graphite electrodes. We stamped both cathodes and anodes to coupons with the dimension of 30 cm×50 cm. We screened tabs from different vendors and used ultrasonic metal spot welder to attach the tabs to electrode coupons. The welding conditions, including the power, frequency and duration, were optimized to maximize the mechanical strength and minimize the electrical resistance of electrodes. We also optimized the sealing conditions, such as heating power and duration, for the best sealing effect.

The tabs for both cathodes and anodes were selected, conditions for tab welding and pouch sealing were identified, and more than six (6) SLP cells were built using printed graphite anodes and conventional cathodes. In addition, no peeling off or cracks were observed on both cathodes and anodes after the tab attachment. This indicates the robust structure of printed electrodes for the cell assembly at large scale.

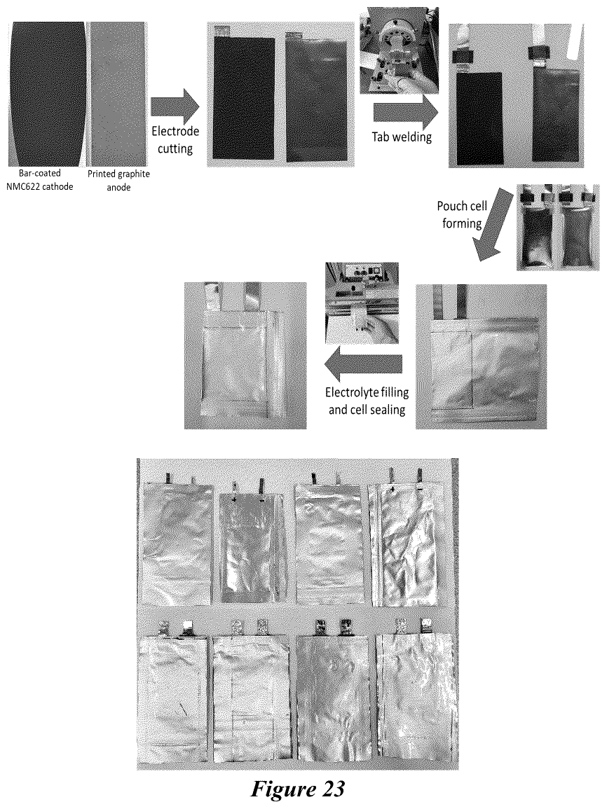

FIG. 23 shows the assembly process (top) of SLP cells with NMC622 cathodes and printed graphite anodes. Photographs of six (6), 20 mAh SLP cells with printed graphite anodes (bottom) built using this process. The smaller tabs used in the top row of four SLP cells were provided by one supplier and the bigger tabs for bottom row came from another vender. All SLP cells is composed of bar coated NMC622 cathodes and printed graphite anodes. All cathodes have the same mass loading of ˜14.1 mg/cm² and porosity of ˜35%. All printed graphite anodes have the same mass loading of ˜7.3 mg/cm², the porosity of ˜35%, vertically aligned pore channels with the pore diameter of 100 μm and edge-to-edge pore distance of 200 μm. The N/P ration in all SLP cells is about 1.1.

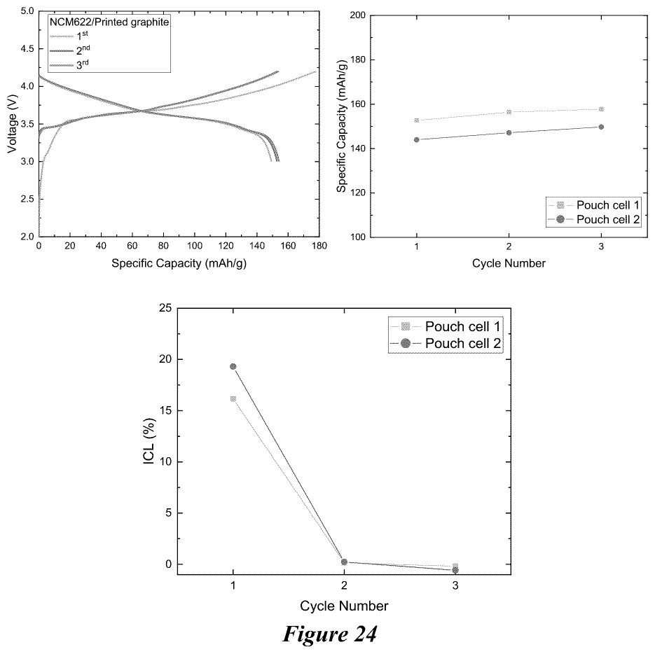

Example 24. Galvanostatic cycling tests of SLP cells assembled in the Example above were conducted on a battery tester room temperature. FIG. 24 shows the voltage profiles (top left), specific capacity and ICL of two representative SLP cells. The constant current density of 0.1C was applied to all cells with the voltage window of 3-4.25V. All SLP cells demonstrated electrochemical performance close to that of coin cells in terms of voltage curves, specific capacity and ICL. Table 3 shows that the assembled SLP cells have the actual capacity of ˜29 mAh, which is higher than our targeted value of 20 mAh.

TABLE 3
Summary of formation test on SLP cells
with printed graphite anodes

| | | Reversible Capacity |
|---|---|---|
| | Coulombic Efficiency | (Discharge Capacity in |
| Cell # | in 1st cycle (%) | 3rd cycle, mAh) |
| 1 | 83.8 | 29.4 |
| 2 | 80.7 | 28.5 |

We investigated the effect of the graphite on the Li plating and found the smaller particles can significantly delay the onset of Li plating and increase SOC of graphite anodes at high current densities. We therefore selected graphite with particle size of <10 μm as the active material of the printed anodes for fast charging batteries.

We also studied the effect of ink solid content and snap-off distance between the screen template and substrate on the quality of printed electrodes. We found that electrodes with excellent quality can be printed when the solid content of the inks was in the range of 55-60% and the snap-off distance was in the range of 25-35.

The predictions from our theoretical models showed that reducing pore size and shortening the pore distance can improve the cell capacity at the Li plating threshold. Experimental results demonstrated that, when the pore diameter and E2E pore distance were decreased to 100 μm and 200 μm respectively, the obtained electrodes showed excellent printing quality and robust structure. We therefore take the porous structure of 100 μm pore and 200 μm E2E pore distance as an optimal electrode structure for further printing and battery applications, although others are possible.

In summary, we have successfully established theoretical models to predict the electrochemical behaviors of printed electrodes and optimized the porous structure of printed electrodes for fast charging batteries via models and experiments. Further, we increased the printing speed to >2 m2/min and printed the electrodes with an optimal porous structure at this high speed. Assembled into cells, the printed electrodes with optimized porous structure demonstrated the capacity retention of >80% at 4C. In addition, we initialized the build of SLP cells with printed electrodes and the assembled SLP cells showed the actual capacity of ˜29 mAh.

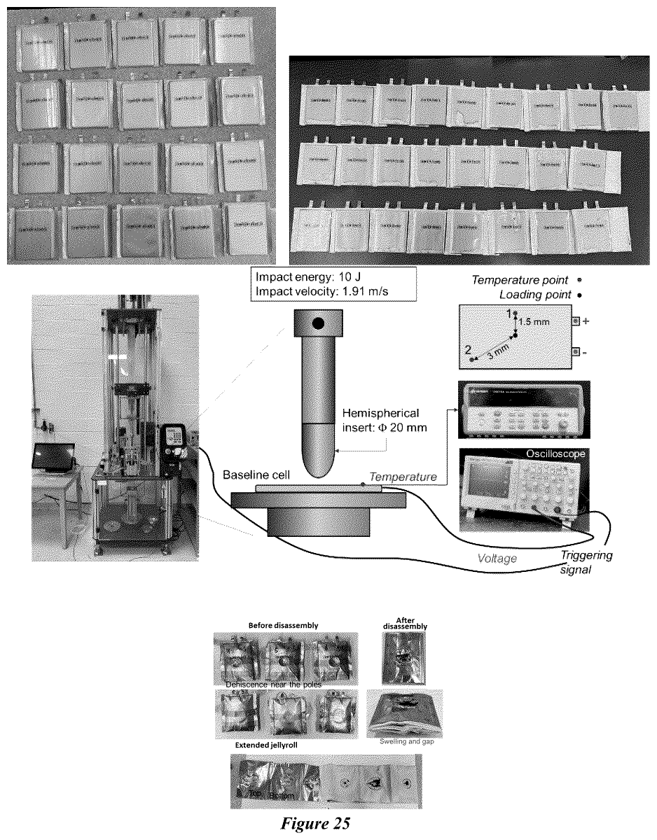

FIG. 25 shows further representative embodiments in terms of photographs of 45 representative 1.5 Ah baseline pouch cells assembled with NCM622 cathode and Mage-3 graphite anode during Budget Period 2. The experiment set up for dynamic impact test (bottom, left) and photos (bottom, right) of cells after the dynamic impact test. Before the test, three cells were charged to 30% SOC.

In some embodiments, the E2E pore distance will be reduced to <100 μm. We believe that Li plating is the culprit for the deteriorated LIB performance under fast charging applications. Results from our theoretical models reveal that shortening the pore distance can facilitate both in plane and through plane mass transportations and delay the onset of Li plating. However, the overall Li-ion diffusion in the electrode could not be significantly improved when the E2E pore distance is too far, especially for thick electrodes. To address this issue, patterned electrodes with <100 □m E2E pore distance will be printed and assembled into cells. With short pore distance, the in-plane Li-ion diffusion distance will be reduced to suppress the Li plating and significantly improve the cycle life of graphite anode.

1-36. (canceled)

37. A screen-printed anode with three or more layers, wherein each layer is printed with a different porosity to optimize the electrode for maximum capacity.

38. The screen-printed anode of claim 37, wherein the anode comprises graphite or silicon as the active material.

39. The screen-printed anode of claim 38, wherein the anode further comprises a conductive additive, and a binder, wherein the ink used to produce the anode further comprises a solvent.

40. The screen-printed anode of claim 39, wherein the graphite is selected from MAGE, MAGE3, P66 (Phillips 66), P5, P10, P15, and T16 or a mixture thereof.

41. The screen-printed anode of claim 39, wherein the binder is selected from one or more of polyvinylpyrrolidone (PVP), polyacrylic acid (PAA), polyvinylidene difluoride (PVDF), carboxymethyl cellulose (CMC), styrene butadiene rubber (SBR) or a mixture thereof.

42. The screen-printed anode of claim 39, wherein the solvent is selected from N-methyl-2-pyrrolidone (NMP), water, ethylene glycol acetate, isopropyl, and ethanol or a mixture thereof.

43. The screen-printed anode of claim 39, wherein the graphite is Phillips 66, the conductive additive is carbon black, and the binder is PVDF.

44. The screen-printed anode of claim 37, wherein the anode comprises three layers, with the top layer having a higher porosity than the middle layer, and the middle layer has a higher porosity than the lower layer.

45. The screen-printed anode of claim 37, where the average porosity of each layer ranges from 100 μm to 1000 μm.

46. The screen-printed anode of claim 37, wherein the porosity of the lowest layer is about 20%, the middle layer about 30% and upper layer about 40%.

47. The screen-printed anode of claim 37, wherein the ink used to print the anode further comprises cellulose nanofibers.

48. The screen-printed anode of claim 37 wherein the anode comprises graphite with a porosity of 100 μm and edge-to-edge differences of 200 to 400 μm.

49. A LI based cell comprising
a screen-printed anode comprising graphite with at least one layer with a porosity of 100 μm and edge-to-edge differences of 200 to 400 μm;
a screen printed cathode comprising a Li-based active material with a pore diameter of about 1000 μm.

50. The cell of claim 49, wherein the Li-base active material is selected from LiFePO₄ and Li2CoO₃ LiNixCo1−x−yMn_{y}O₂ (NCM) or mixtures thereof.

51. The cell of claim 49, wherein the cathode material is printed with an ink comprising a solvent selected from water, isopropyl, ethanol, NMP and their mixtures.

52. The cell of claim 49, wherein the screen-printed anode comprising graphite is comprised of at least three layer with differing porosities.
